(19) United States
(12) Patent Application Publication
(10) Pub. No.: US 2005/0118962 A1
(43) Pub. Date: Jun. 2, 2005

(54) Receiver reuse switching

(75) Inventor: Arthur E. Sheiman, Mountain Lakes, NJ (US)

Correspondence Address: VENABLE, BAETJER, HOWARD AND CIVILETTI, LLP, P.O. BOX 34385, WASHINGTON, DC, 20043-9998, US

(73) Assignee: Intel Corporation, Santa Clara, CA (US)

(21) Appl. No.: 10/724,252

(22) Filed: Dec. 1, 2003

(51) Int. Cl. H04B 1/00; H04B 15/00; H04B 1/44

(52) U.S. Cl. 455/78; 455/63.1

(57) ABSTRACT

A leaky transmit/receive switch may be used in a transceiver to permit the receiver to receive a portion of transmitted signal energy.

### BACKGROUND OF THE INVENTION

A communication system may include collocated transmitters and receivers, which may be paired off into transceiver arrangements. In such arrangements, the transmitter and receiver may be adapted to utilize at least some of the same circuitry, for example, a single antenna. If the communication system uses frequency-division duplexing (FDD), the transmitter and the receiver use different frequency bands, which minimizes interference between the transmitter and the receiver. However, many systems use time-division duplexing (TDD) of transmitting and receiving in a common frequency band.

When both transmitter and receiver are arranged to operate in the same frequency band, for example, for half-duplex communications, the receiver may receive the transmitted signal, from the transmitter, unless steps are taken to prevent this. Often, a transmit/receive (T/R) switch is employed to prevent transmitted energy from being received by the receiver and possibly damaging the receiver. Generally, such T/R switches prevent substantially any of the transmitted energy from being received by the receiver.

### BRIEF DESCRIPTION OF THE DRAWINGS

Preferred embodiments of the invention will now be described in connection with the associated drawings, in which:

FIG. 1 depicts a conceptual block diagram of a system implementing an exemplary embodiment of the invention;

FIG. 2 depicts a conceptual block diagram of an exemplary embodiment of the invention; and

FIG. 3 depicts a conceptual block diagram a further exemplary embodiment of the invention.

### DETAILED DESCRIPTION OF PREFERRED EMBODIMENTS

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Embodiments of the present invention may include apparatuses for performing the operations herein. An apparatus may be specially constructed for the desired purposes, or it may comprise a general purpose device selectively activated or reconfigured by a program stored in the device.

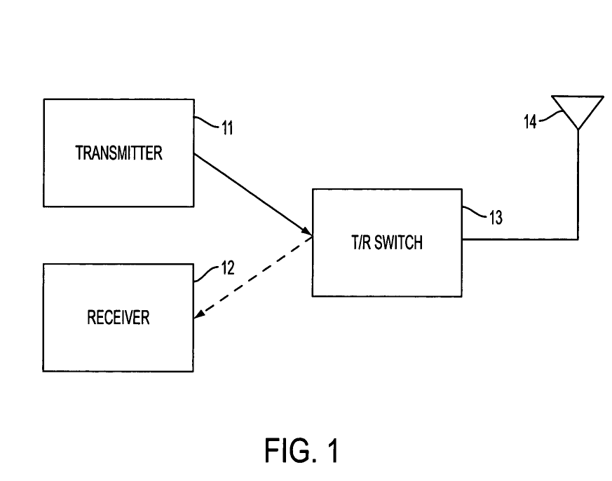

FIG. 1 depicts a conceptual block diagram of an exemplary embodiment of the invention. As shown, a transmitter 11 and a receiver 12 may share a common antenna 14. This may be facilitated by using a T/R switch 13. The T/R switch 13 of FIG. 1 is shown for the case in which transmitter 11 is active (transmitting a signal).

According to an embodiment of the invention, T/R switch 13 may be deliberately “leaky.” That is, T/R switch may be arranged so as to permit some transmitted signal energy to be received by receiver 12, as shown by the dotted line in FIG. 1. Receiver 12 may then demodulate the transmitted signal. The demodulated transmitted signal may be further processed, for example, to permit adjustment of transmitter 11 (but not limited to this use).

Adjustments of transmitter 11 may include, but are not limited to, linearization by pre-distortion of transmitted signals and/or transmitter diagnostics (for example, by comparing the received signal to the transmitted signal). Such adjustments may be used, for example, to provide highly linear precise modulation and/or to provide low spectral re-growth, e.g., to meet adjacent-channel leakage ratio (ACLR) requirements in various types of systems. In such a case, transmitter 11 may be equipped with a pre-distortion portion (not shown).

In order to permit receiver 12 to properly demodulate the transmitted signal, T/R switch 13 may need to regulate the amount of transmit signal energy being leaked to receiver 12. In particular, if too much energy is permitted to enter receiver 12, it may cause receiver 12 to overload and/or to operate non-linearly. If too little energy is permitted to enter receiver 12, on the other hand, the received signal-to-noise ratio (SNR) may be insufficient to permit demodulation, or at least to permit accurate demodulation.

In view of the above, in one embodiment, T/R switch 13 may be designed to allow only a certain predetermined amount of transmitted signal energy to leak into receiver 12, such that the above requirements may be met.

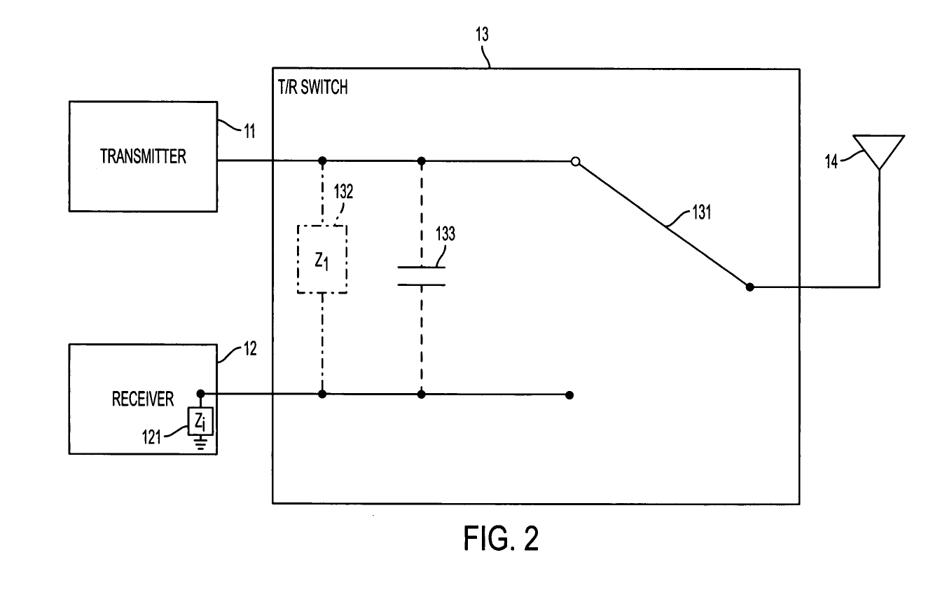

FIG. 2 shows a partial circuit diagram of an embodiment of the invention, including an exemplary implementation of a T/R switch 13. In particular, T/R switch 13 may comprise a switch 131, which may have a parasitic impedance, for example, but not limited to, capacitance 133, that permits some energy from transmitter 11 to enter receiver 12. In general, impedance (capacitance) 133 may form a voltage divider with an input impedance 121, say Zᵢ, of receiver 12, which determines an amount of leakage energy from transmitter 11 to receiver 12. To adjust the amount of leakage energy, a further leakage path 132, which may be an impedance, Z₁ may be added between transmitter 11 and receiver 12. Note that, in general, an output impedance of transmitter 11 may be negligible in comparison with an impedance of added leakage path 132.

Switch 131, along with possible parasitic impedance 133, may be implemented in numerous ways. Exemplary implementations may include, but are not limited to, manual switches, PIN diode-based switches, mechanical relays, and transistor switches (for example, but not limited to, field-effect transistor (FET) switches). The implementation of switch 131 may, for example, be tailored to meet the characteristics of the type of signaling to be used (for example, but not limited to, frequency, bandwidth, modulation type, and the like).

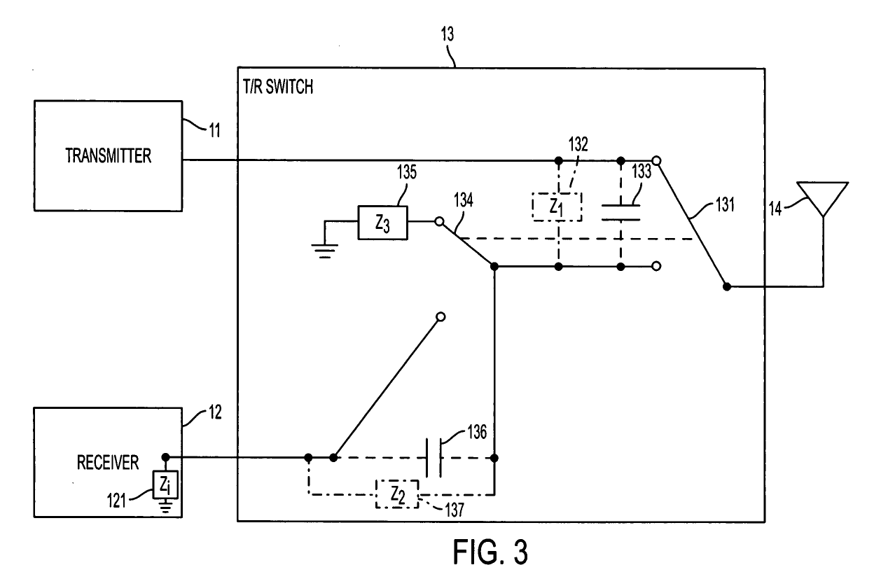

T/R switch 13, however, need not necessarily be implemented by a single switching stage, but additionally, may be implemented using multiple switching stages. Multiple switching stages may permit increased isolation and may be useful in cases where a single-stage switch design has enough parasitic feedthrough that the receiver may end up operating above its desired operating point, e.g., be “overloaded.” FIG. 3 shows an example of such an implementation, using two cascaded switches, 131 and 134. Switches 131 and 134 may be coordinated so that they may be in corresponding positions for connecting either transmitter 11 or receiver 12 to antenna 14 (shown as the “up” position in FIG. 3, but not limited thereto). Each switch, 131 or 134, may have an associated parasitic impedance, 133 or 136, respectively, which, together, may permit leakage of energy into receiver 12 when the switches 131 and 134 are set to connect transmitter 11 with antenna 14 (in this case, switch 134 may be connected to an impedance 135, denoted Z₃, which may be coupled to ground). Additional leakage paths 132 and 137, respectively, which may comprise impedances Z₁ and Z₂, respectively, may be added to provide additional leakage between transmitter 11 and receiver 12. Note that an amount of leakage energy may again be determined by considering voltage dividers formed by impedances 132, 133, 135, 136, and 137, along with the input impedance 121 of receiver 12, as discussed above. Note again that an output impedance of transmitter 11 may generally be negligible in comparison with the impedances of added leakage paths 132 and 137.

In a particular implementation, by making the impedances Z₁ and Z₃ significantly smaller than the impedance of the parasitic elements 133 and 136, respectively, one may make the leakage less dependent upon the parasitics. This may be advantageous in that the parasitic impedances may vary from unit to unit in production, and they may also vary with environmental parameters (e.g., temperature). However, the invention is not limited to this implementation, and, to the contrary, Z₁ and Z₃ may be made arbitrarily high or may be omitted (i.e., leaving open circuits in FIG. 3). The decision regarding the sizes of Z₁ and Z₃ may depend upon such factors as application requirements and/or repeatability of the parasitics.

As discussed above, the implementations of the switches 131 and 134 in FIG. 3, along with their possible parasitic impedances 133 and 136, may be implemented in numerous ways, non-limiting examples of which are discussed above. Again, the implementations of switches 131 and 134 may, for example, be tailored to meet the characteristics of the type of signaling to be used (for example, but not limited to, frequency, bandwidth, modulation type, and the like).

The invention has been described in detail with respect to preferred embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. An apparatus, comprising:
a transmit/receive switch adapted to leak sufficient energy to a receiver during transmission such that the receiver is able to correctly demodulate a transmitted signal.

2. The apparatus according to claim 1, wherein the transmit/receive switch is further adapted to prevent an amount of energy leaked to said receiver from being sufficient to overload the receiver.

3. The apparatus according to claim 1, wherein the transmit/receive switch comprises:
a switch selectively coupled to a transmit output and a receive input, said switch comprising a parasitic impedance between said transmit output and said receive input.

4. The apparatus according to claim 3, wherein the transmit/receive switch further comprises:
another leakage path between said transmit output and said receive input.

5. The apparatus according to claim 4, wherein said another leakage path comprises an impedance.

6. The apparatus according to claim 3, wherein said switch comprises at least one of a manual switch, an electromechanical relay, a transistor switch, and a PIN diode.

7. A system, comprising:
a transmitter;
a receiver; and
a transmit/receive switch, coupled to said transmitter and to said receiver and adapted to leak sufficient energy to said receiver during transmission by said transmitter such that said receiver is able to correctly demodulate a signal transmitted by said transmitter.

8. The system according to claim 7, wherein said transmit/receive switch is further adapted to prevent an amount of energy leaked to said receiver from being sufficient to overload said receiver.

9. The system according to claim 7, further comprising:
an antenna used by both said transmitter and said receiver and coupled to said transmit/receive switch.

10. The system according to claim 7, wherein said transmit/receive switch comprises:
a switch selectively coupled to said transmitter and said receiver, said switch comprising a parasitic impedance across said switch between said transmitter and said receiver.

11. The system according to claim 10, wherein said transmit/receive switch further comprises:
another leakage path across said switch between said transmitter and said receiver.

12. The system according to claim 11, wherein said another leakage path comprises an impedance.

13. The system according to claim 12, wherein said impedance is greater than an input impedance of said receiver.

14. The system according to claim 10, wherein said switch comprises at least one of a manual switch, an electromechanical relay, a transistor switch, and a PIN diode.

15. The system according to claim 7, wherein a signal demodulated by said receiver during transmission by said transmitter is fed back to said transmitter.

16. The system according to claim 15, wherein said transmitter is adapted to use said signal demodulated by said receiver during transmission by said transmitter to perform at least one of linearization and self-diagnostics.

17. A method, comprising:
providing a transmit/receive switch adapted to leak sufficient energy to a receiver during transmission such that the receiver is able to correctly demodulate a transmitted signal.

18. The method according to claim 17, wherein the transmit/receive switch is further adapted to prevent an amount of energy leaked to said receiver from being sufficient to overload the receiver.

19. The method according to claim 17, further comprising:
providing a transmitter adapted to be coupled to said transmit/receive switch; and
providing a receiver adapted to be coupled to said transmit/receive switch.
